(19) United States
(12) Patent Application Publication
(10) Pub. No.: US 2013/0099574 A1
(43) Pub. Date: Apr. 25, 2013

(54) SYSTEM AND METHOD FOR MULTIPLE POWER SUPPLIES

(71) Applicants: Richard Scott BOURGEOIS, Albany, NY (US); Herman Lucas Norbert Wiegman, Niskayuna, NY (US)

(72) Inventors: Richard Scott BOURGEOIS, Albany, NY (US); Herman Lucas Norbert Wiegman, Niskayuna, NY (US)

(21) Appl. No.: 13/279,966

(22) Filed: Oct. 24, 2011

(51) Int. Cl. H02J 9/00

(52) U.S. Cl. 307/66; 307/64

(57) ABSTRACT

A system having multiple uninterruptable power supplies switchably coupled to a single energy storage device. The uninterruptable power supplies are switchably coupled to the single energy storage device (e.g., a bank or collection of energy storage elements) by at least one disconnect switch assembly that includes at least a first switch coupled to the first uninterruptable power supply and a second switch coupled to the second uninterruptable power supply.

### BACKGROUND

### TECHNICAL FIELD

Embodiments of the subject matter disclosed herein relate to energy storage systems. Other embodiments relate to uninterruptable power supplies.

1. Discussion of Art

Uninterruptable power supplies have battery systems that enable the uninterruptable power supply to provide power to a load when there is an interruption in a utility power grid or when there are quality issues with the incoming electrical supply. Current battery systems include dedicated battery systems for each uninterruptable power supply (UPS), for example, two uninterruptable power supplies, each of which has a battery system connected to it which serves only that uninterruptible power supply. Such systems are expensive and require UPS downtime when the batteries are serviced.

It would therefore be desirable to develop a system with battery system features and characteristics that differ from those of systems that are currently available.

2. Brief Description

In an embodiment, a system is provided having a single energy storage device, a first uninterruptable power supply switchably coupled to the single energy storage device, and at least one second uninterruptable power supply switchably coupled to the single energy storage device. As used herein, the term “single energy storage device” refers to an energy storage device that is electrically shared by two or more uninterruptible power supplies (UPS's), as opposed to each UPS having its own dedicated energy storage device; in at least one mode of operation, each UPS can potentially receive power from any part of the energy storage device. The system also comprises at least one disconnect switch assembly that includes at least two switches including a first switch (e.g., a dual pole switch) coupled to the first uninterruptable power supply, and a second switch (e.g., a dual pole switch) coupled to the second uninterruptable power supply. The at least one disconnect switch assembly is operatively connected externally and/or internally to the single energy storage device. Each switch has an on state and an off state to enable the energy storage device to electrically communicate with either or both uninterruptable power supplies (e.g., based on whether the switches are in the on state or off state). In another embodiment, the system further comprises a controller that is configured to control the at least one disconnect switch assembly and switching of the at least two switches between the on state and the off state, depending on the current mode of operation of the controller.

Another embodiment relates to a method. The method comprises a step of controlling at least one disconnect switch assembly to supply backup power from a single energy storage device to at least two uninterruptable power supplies, including a first uninterruptable power supply and a second uninterruptable power supply, over at least two electrical busses. In another embodiment, the method includes a step of controlling the at least two uninterruptable power supplies to supply input power from at least one alternating current feed to the single energy storage device and/or a load.

### BRIEF DESCRIPTION OF THE DRAWINGS

Reference is made to the accompanying drawings in which particular embodiments of the invention are illustrated as described in more detail in the description below, in which:

FIG. 1 is a schematic of a system having uninterruptable power supplies and a single energy storage device, according to an embodiment of the invention;

FIG. 2 are schematics of alternative disconnect switch assemblies connected to a battery in the single energy storage device, according to various embodiments;

FIG. 3 is a schematic of the system having uninterruptable power supplies and a single energy storage device of FIG. 1, showing a different mode of operation;

FIG. 4 is a schematic of the system having uninterruptable power supplies and a single energy storage device of FIG. 1, showing another mode of operation;

FIG. 5 is a schematic of the system having uninterruptable power supplies and a single energy storage device of FIG. 1, showing another mode of operation;

FIG. 6 is a flowchart of an embodiment of a method of monitoring and controlling the system having uninterruptable power supplies and a single energy storage device of FIGS. 1-5;

FIG. 7 is a schematic of another embodiment of the system having uninterruptable power supplies and a single energy storage device; and

FIG. 8 is a schematic of yet another embodiment of the system having uninterruptable power supplies and a single energy storage device.

### DETAILED DESCRIPTION

Embodiments relate to a system and method having a single energy storage system and multiple uninterruptable power supplies. With reference to the drawings, like reference numerals designate identical or corresponding parts throughout the several views. However, the inclusion of like elements in different views does not mean a given embodiment necessarily includes such elements or that all embodiments of the invention include such elements.

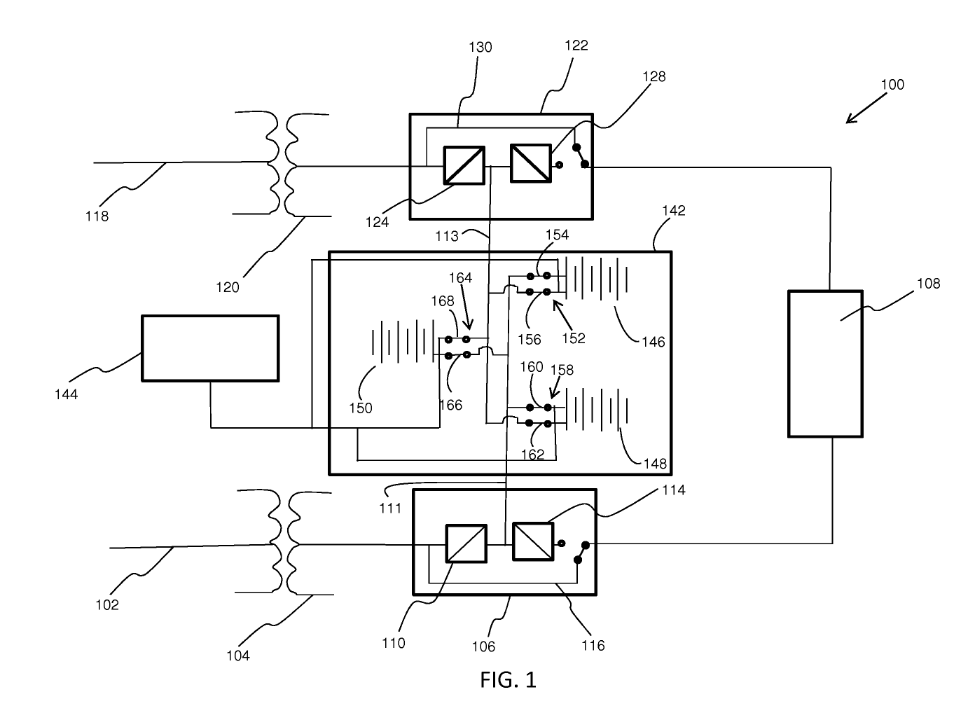

FIG. 1 illustrates an electrical schematic of a system 100 having batteries and uninterruptable power supplies. The system 100, e.g., a power system, electrically connects a first grid alternating current feed 102 and a first transformer 104, e.g., a step down transformer, to a first uninterruptable power supply 106 that is configured to continuously provide at least a portion of a power requirement to a load 108. The load represents a load required by telecommunications data centers, computer centers, and electrical equipment, for example. The first uninterruptable power supply 106 includes a rectifier 110 (also known as a charger) that converts the first grid alternating current feed 102 from alternating current power (“AC power”) to direct current power (“DC power”) before charging a single energy storage device 142 (discussed further below). Furthermore, the first uninterruptable power supply 106 includes an inverter 114 that converts the DC power from the energy storage device into AC power to supply power to the load 108, e.g., continuously or when there is a power surge, brownout, or line noise from the first grid alternating current feed 102. The rectifier and inverter can be any type, size, capacity, and configuration known by one skilled in the art of power systems. In the illustrated embodiment, the first uninterruptable power supply 106 further includes a load power line and switch 116 that supplies AC power to the load 108 after the first uninterruptable power supply 106 ensures that the power from transformer 104 is of adequate quality.

Further, the system 100 schematically illustrated in FIG. 1 includes a second grid alternating current feed 118 and a second transformer 120 electrically connected to a second uninterruptable power supply 122 that is configured to continuously provide at least a portion of the power to the load 108. Similar to the first uninterruptable power supply 106, the second uninterruptable power supply 122 includes a rectifier 124 (also known as a charger) that converts the second grid alternating current feed 118 from AC power to DC power before charging the single energy storage device 142 (discussed further below). Furthermore, the second uninterruptable power supply 122 includes an inverter 128 that converts the DC power from the energy storage device into AC power to supply power to the load 108. The second uninterruptable power supply 122 further includes a load power line and switch 130 that supplies AC power to the load 108 from the grid and transformer. Even though the electrical connections between the UPS's and the energy storage device are shown as single line connections, it is to be understood that the single line connections represent DC+ and DC− connections.

FIG. 1 further illustrates system 100 having a single energy storage device 142 and a controller 144. The system 100 may be configured to include a single energy storage device and at least two uninterruptable power supplies configured to supply electricity to at least a portion of the load 108. For example, a single energy storage device and four uninterruptable power supplies that are each adapted to supply a portion of the load, up to one-hundred percent of the load, may be provided. Furthermore, the system 100 may include uninterruptable power supplies of different configurations, including but not limited to on-line, e.g., double conversion on-line, line-interactive, or standby uninterruptable power supply systems. In another alternative embodiment, the system 100 may not include redundant or dedicated grid alternating current feeds, but rather may be configured with a single grid alternating current feed that is electrically connected to both uninterruptable power supplies. In yet another embodiment, the system may include uninterruptable power supplies that are each electrically connected to two or more grid alternating current feeds, e.g., a first grid alternating current feed connectable to a first uninterruptable power supply and at least two second grid alternating current feeds connectable to at least one second uninterruptable power supply. A grid alternating current feed is defined to mean a connection to the public power grid for receiving AC power, a connection to a diesel generator for receiving AC power, or any other source of AC power.

As shown in FIG. 1 and discussed above, the system 100 includes the single energy storage device 142 (comprising at least one battery or other energy source, e.g., source of electrical energy) and at least one disconnect switch assembly 152, 158, 164. The single energy storage device 142 and disconnect switch assembly/assemblies may be assembled as a single unit or package. For example, the single energy storage device may include electro-mechanical (e.g., flywheel) energy source(s) (with or without power conditioning equipment), and/or electro-static (e.g., capacitor) energy source(s) (with or without power conditioning equipment). Regardless of type, the energy sources of the single energy storage device may be configured to supply a voltage/power requirement of a load via the first uninterruptable power supply and the second uninterruptable power supply. In another embodiment, the system may include a single energy storage device that comprises at least one battery or other energy source, at least one disconnect switch assembly, and at least one uninterruptable power supply.

In the illustrated embodiment, the single energy storage device includes a first battery 146, a second battery 148, and a third battery 150 that are each switchably coupled to the first uninterruptable power supply 106 and the second uninterruptable power supply 122 via a dual bus configuration having a first electrical bus 111 and a second electrical bus 113. The first, second, and third batteries are connected in parallel and are switchably coupled to each uninterruptable power supply. The batteries in the single energy storage device may include, but are not limited to, at least one of the following electro-chemical storage technologies having electro-chemical cells: lead acid, sodium metal halide, lithium, and nickel-cadmium. Other types of electro-chemical technologies are possible as well. Further, the batteries may include any battery type, size, and energy capacity, including, but not limited to non-rechargeable and rechargeable batteries, e.g., a multi-cell battery, a 500 volt battery, 240 volt wet acid batteries, lithium-ion batteries, nickel metal hydride batteries, sodium-sulfur batteries, and the like. However, in general, every battery in a particular single parallel system embodiment (i.e., embodiment where multiple batteries are connected in parallel) operates at the same voltage and is typically of the same type and has the same number of cells as the other batteries in the system.

In accordance with an embodiment, the system 100 further includes at least one disconnect switch assembly for each battery or other energy source of the single energy storage device 142. In the illustrated embodiment, the first battery 146 is operatively connected to a first disconnect switch assembly 152 having a first switch 154 switchably coupled to the first uninterruptable power supply 106 and a second switch 156 switchably coupled to the second uninterruptable power supply 122, e.g., a dual disconnect switch assembly. Each switch is controllable (e.g., switchable) between an on state, for establishing one or more electrical connections, and an off state, for establishing one or more electrical open conditions. In accordance with an embodiment, each switch 154 and 156 is a two-pole switch providing the ability to switch in/out DC positive and negative potentials from the batteries (even though only a single line connection is shown in the figure). In the mode of operation shown in FIG. 1, the first switch 154 and the second switch 156 are both switched to the on state and are enabling the energy storage device, i.e., first battery 146, to electrically communicate with the first uninterruptable power supply 106 and the second uninterruptable power supply 122, respectively, over respective electrical buses 111 and 113 of the dual bus configuration.

In the illustrated embodiment, the switches of the disconnect switch assembly are contact switches. In another embodiment, the switches of the disconnect switch assembly are at least one of the following: a contact switch, a motor actuated switch, a motor actuated breaker, and/or a circuit breaker. Again, the switches are two-pole switches, in accordance with an embodiment. However, in accordance with an alternative embodiment, the switches may be single-pole switches, to connect/disconnect only the DC+ (positive) side or the DC− (negative) side of the battery.

Further in the illustrated embodiment, the second battery 148 is operatively connected to a second disconnect switch assembly 158 having a first switch 160 switchably coupled to the first uninterruptable power supply 106 and a second switch 162 switchably coupled to the second uninterruptable power supply 122. Furthermore, the third battery 150 is operatively connected to a third disconnect switch assembly 164 having a first switch 166 switchably coupled to the first uninterruptable power supply 106 and a second switch 168 switchably coupled to the second uninterruptable power supply 122. In the mode of operation shown in FIG. 1, the first and second switches connected to each battery are each switched to the on state and are enabling the energy storage device to supply DC power to each uninterruptable power supply. In other words, the batteries in the single energy storage device 142 are connected in parallel and are each supplying at least a portion of the power required by the load 108. In another embodiment, each disconnect switch assembly includes more than two switches that are switchably connected to more than two uninterruptable power supplies, i.e., one switch for each uninterruptable power supply.

In the illustrated embodiment, the first disconnect switch assembly 152, second disconnect switch assembly 158, and third disconnect switch assembly 164 are configured to be internal to a housing of the single energy storage device 142 that also includes the batteries, i.e., the housing houses the batteries and the disconnect switch assemblies. In another embodiment, the first disconnect switch assembly, the second disconnect switch assembly, and/or the third disconnect switch assembly may be configured to be located in another location, e.g., external to a housing of the single energy storage device.

In accordance with an embodiment, the system 100 further includes the controller 144 that is configured to monitor the system 100 for detection of operating events and configured to control each switch in the at least one disconnect switch assembly in response to the monitoring. For example, an operating event may include, but is not limited to, a battery source fault, an overheating battery, an uninterruptable power supply fault, an overheating uninterruptable power supply, a supply voltage fault, a disconnect switch assembly fault, and/or a load demand reduction. The controller 144 controls each switch of the disconnect switch assemblies and also controls when each switch electrically connects each battery to each uninterruptable power supply. In another embodiment, the controller may monitor the system or control the system based on input or output from another control system. In yet another embodiment, the system is configured to have two or more controllers that are each configured to be associated with at least one of the following: a disconnect switch assembly, an uninterruptable power supply, and/or a single energy storage device. In general, the controller can be implemented in a centralized manner or a distributed manner, in accordance with various embodiments of the present invention.

The controller is illustrated in FIG. 1 as electrically communicating with each individual switch in each disconnect switch assembly, e.g., the controller includes a control bus that connects to each switch. In another embodiment, the controller electrically communicates with at least one of the following: at least one disconnect switch assembly, at least one uninterruptable power supply, at least one grid alternating current feed, at least one transformer, and/or at least one load. In another embodiment, the controller controls the at least one disconnect switch assembly in response to a manual command, e.g., one of the two or more uninterruptable power supplies is manually taken off line and the controller disrupts the electrical communication between the one uninterruptable power supply and the connected batteries.

In accordance with an alternative embodiment, the controller 144 is not present in the system 100 and the disconnect switch assemblies are operated based on a local battery monitor of each battery. That is, a battery can disconnect itself from one or more of the uninterruptible power supplies via the corresponding disconnect switch assembly. A local battery monitor may monitor for certain types of internal battery faults and/or overheating conditions. For example, in battery 150, if a battery fault occurs or the battery overheats, a local battery monitor within the battery can send a signal to the disconnect switch assembly 164, commanding the switches 166 and 168 to open, disconnecting the battery 150 from each of the uninterruptible power supplies 122 and 106. In such an alternative embodiment, faults at other locations in the system 100 (other than battery-related faults) do not affect the disconnect switch assemblies. Such an alternative embodiment can be simpler and less costly than embodiments which include the controller 144.

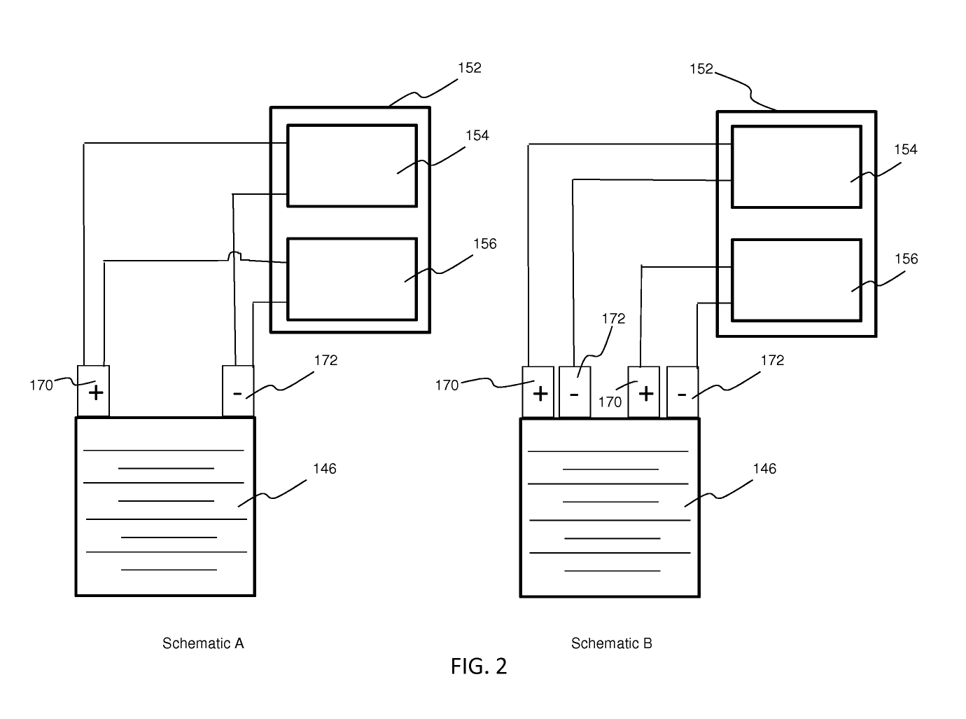

FIG. 2 illustrates two schematics (Schematics A and B) of alternative arrangements of a disconnect switch assembly connected to a battery in the single energy storage device illustrated in FIG. 1. Illustrated in Schematic A is disconnect switch assembly 152 having a first switch 154 and a second switch 156 in electrical communication with the first battery 146. The first battery 146 includes one positive electrical terminal 170 and one negative electrical terminal 172, both connected to corresponding positive and negative connections on the first switch 154 and the second switch 156. Schematic B is substantially similar to schematic A, except the first battery 146 includes two pairs of positive electrical terminals 170 and negative electrical terminals 172. The first switch 154 is in electrical communication with a first positive electrical terminal 170 and a first negative electrical terminal 172 on the first battery 146, and the second switch 156 is in electrical communication with a second positive electrical terminal 170 and a second negative electrical terminal 172 on the first battery 146. In another embodiment, the disconnect switch assembly includes three or more switches and the battery includes one pair of positive and negative electric terminals electrically connected to the switch, or the battery includes three or more pairs of positive and negative electric terminals, each pair electrically connected to at least one switch. In yet another embodiment, the battery may include more than one compartment or cell. The electrical terminals of the batteries (cells) may be connected in series, in parallel, or in some combination of series and parallel connections between adjacent batteries (cells), depending on the application.

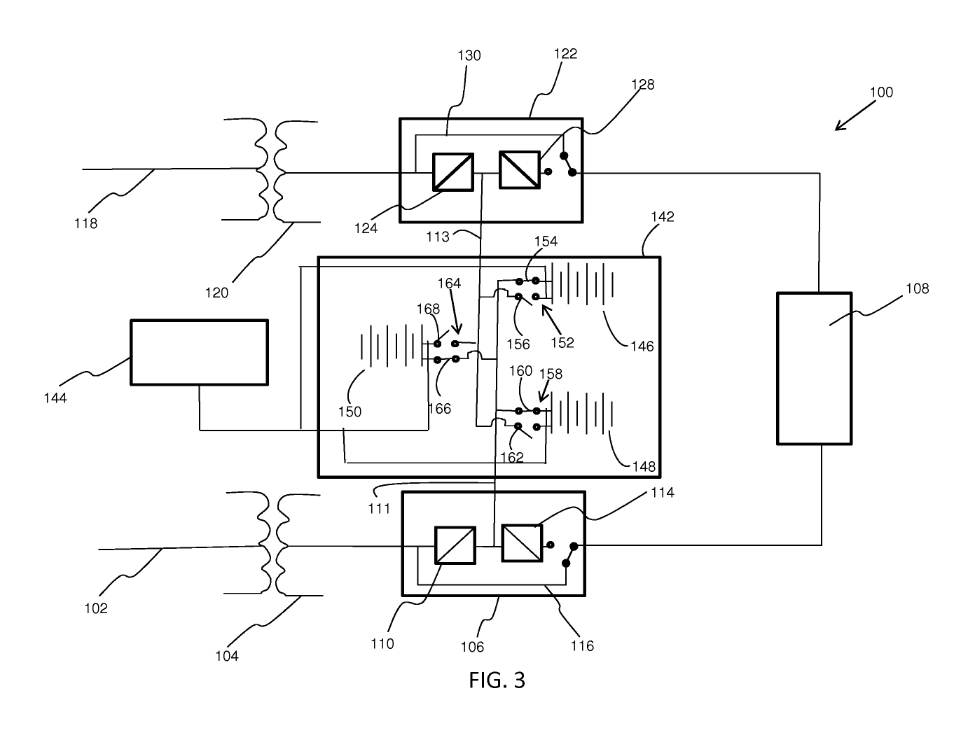

FIG. 3 is an electrical schematic of the system 100 as discussed above and illustrated in FIG. 1, except the system 100 illustrated in FIG. 3 shows the first and second switches of the disconnect switch assemblies in alternative on and off arrangements (relative to FIG. 1). For example, the controller 144 may indicate that the second uninterruptable power supply 122 is experiencing a fault condition, therefore, the controller 144 may switch the second switch in each disconnect switch assembly to an off state so each second switch is not in electrical communication with the second uninterruptable power supply 122 (as illustrated in FIG. 3). In FIG. 3, first switches 154, 160, and 166 remain in an on state (closed connection) and second switches 156, 162, and 168 are switched to an off state (open connection) by the controller 144.

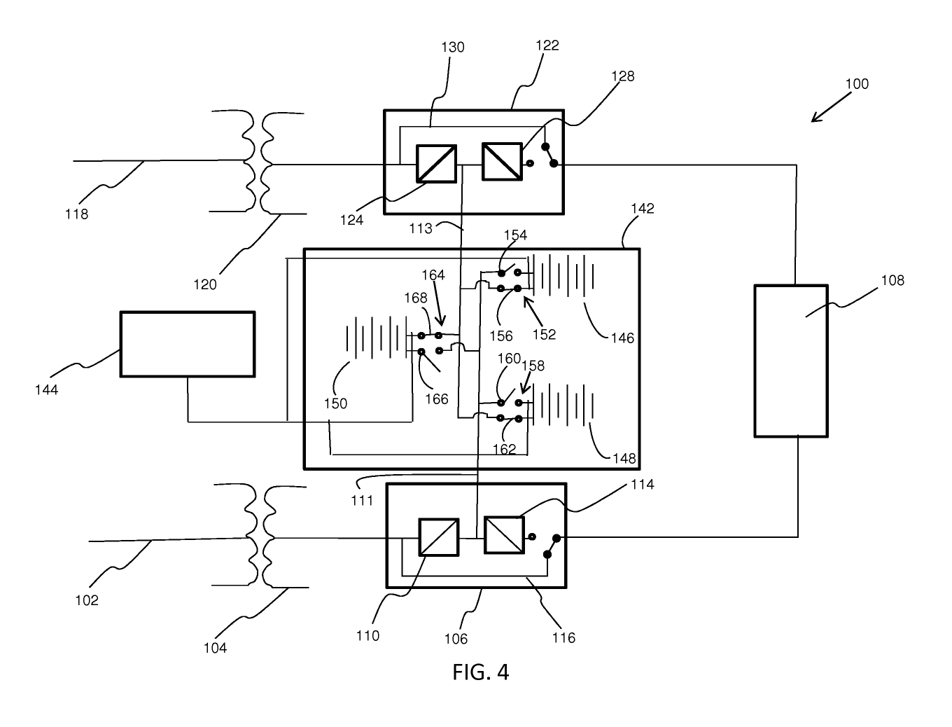

FIG. 4 is an electrical schematic of the system 100 as discussed above and illustrated in FIG. 1, except the system 100 illustrated in FIG. 4 shows the first and second switches of the disconnect switch assemblies in yet another alternative on and off arrangement (relative to FIG. 1). For example, the controller 144 may indicate that the first uninterruptable power supply 106 has a fault condition, therefore, the controller 144 may switch the first switch in each disconnect switch assembly to an off state so each first switch is not in electrical communication with the first uninterruptable power supply 106 (as illustrated in FIG. 4). In this second example, first switches 154, 160, and 166 are switched from an on state to an off state (open connection) and second switches 156, 162, and 168 remain in an on state (closed connection) by controller 144.

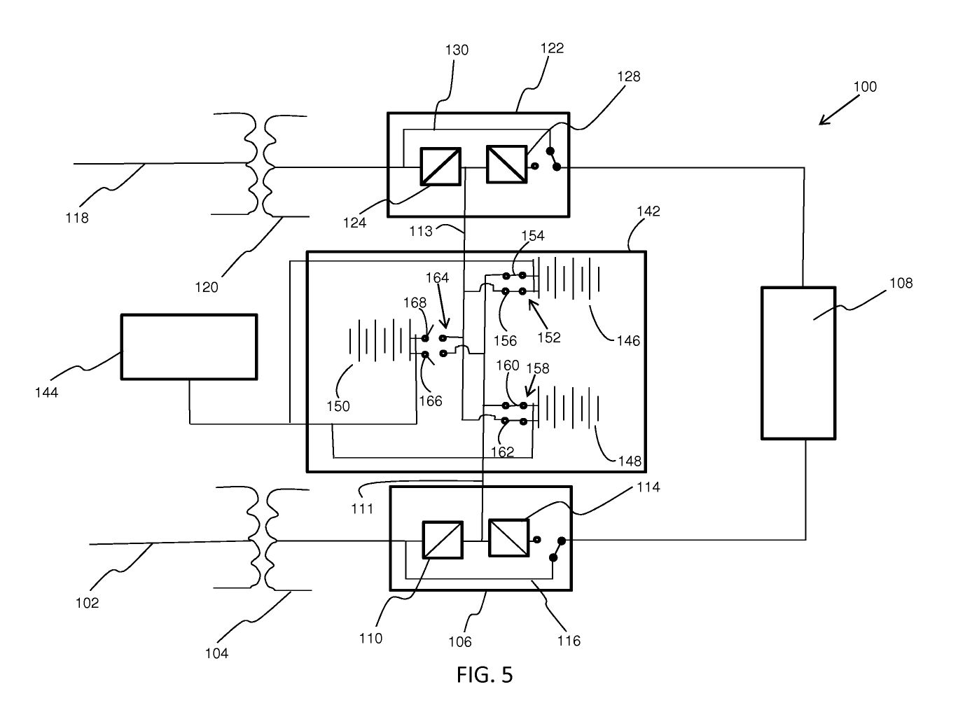

FIG. 5 is yet another electrical schematic of the system 100 discussed above and illustrated in FIG. 1, except the system 100 illustrated in FIG. 5 shows the first and second switches of the disconnect switch assembly 164 both disconnected (both in the off state). For example, the controller 144 may have indicated that the third battery 150 was overheating or experienced another fault condition, therefore, the controller may have moved the first switch 166 and the second switch 168 of the third disconnect switch assembly 156 both to the off state (open connection), i.e. not electrically connected. In another embodiment, the first switch 166 and the second switch 168 may be manually switched to an off state (open connection) so maintenance can be performed on the third battery 150 without interrupting power supply to the load.

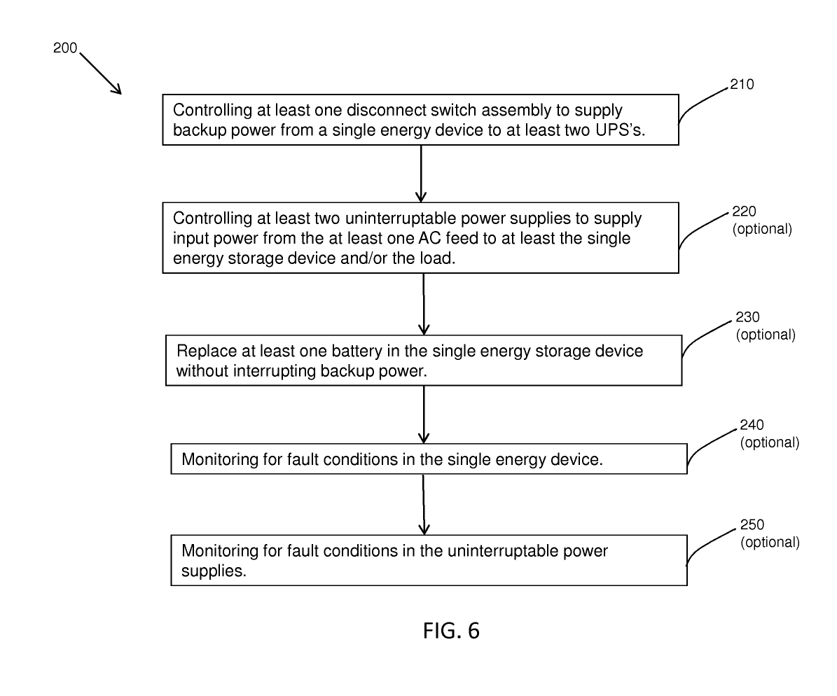

FIG. 6 is a flowchart of an embodiment of a method 200 of controlling the uninterruptable power supply system and the single energy storage device discussed above and illustrated in FIGS. 1-5. In step 210 of the method 200, at least one disconnect switch assembly is controlled to supply backup power from a single energy storage device to at least two uninterruptable power supplies. In step 220, the at least two uninterruptable power supplies are controlled to supply input power from the at least one alternating current feed to at least one of the following: the single energy storage device and/or a load. In optional step 230, at least one battery in the single energy storage device is replaced without interrupting the backup power to the at least two uninterruptable power supplies. In optional step 240, the method further includes monitoring of the single energy storage device for fault conditions, and in optional step 250 the method includes monitoring of the uninterruptable power supplies for fault conditions.

Faults or degradation of the system 100 can occur at other points in the system 100 as well, and the controller 144 can monitor the system 100 and adapt the switch assemblies accordingly, in accordance with an embodiment. For example, a fault between the first uninterruptable power supply and the load or a fault between the second grid alternating current and the second uninterruptable power supply will cause the controller to electrically disconnect the corresponding switches in the switch assemblies.

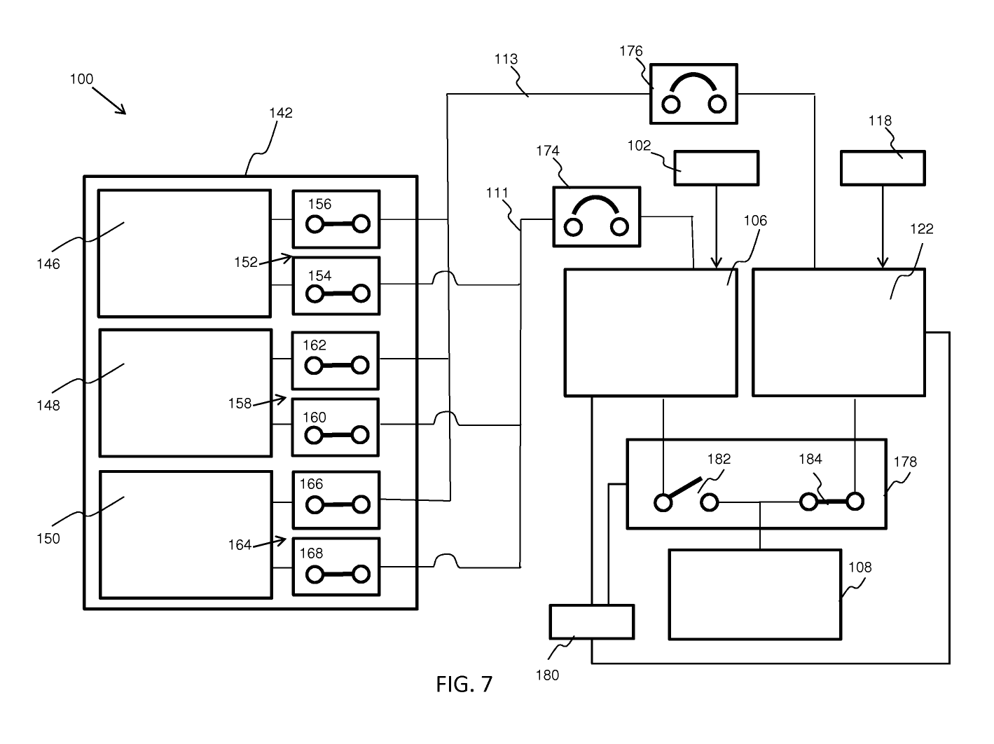

FIG. 7 is an electrical schematic of an alternative embodiment of the system 100 that is substantially similar to the system 100 discussed above and illustrated in FIG. 1, except the system 100 illustrated in FIG. 7 does not include the controller 144 and includes additional system components. In the embodiment of FIG. 7, the disconnect switch assemblies 152, 158, and 164 are triggered by signals from local battery monitors within the batteries. System 100 illustrated in FIG. 7 includes a first breaker 174 in electrical communication between the first electrical bus 111 and the first uninterruptable power supply 106 and a second breaker 176 in electrical communication between the second electrical bus 113 and the second uninterruptable power supply 122. The breakers are configured to allow the uninterruptable power supplies to isolate themselves from the corresponding electrical bus when the uninterruptable power supplies, for example, are faulty or not performing at a minimum level. The first and second breakers can be mechanical and/or electro-mechanical in design, including single pole and dual pole breakers that can move between an on state (closed connection) to an off state (open connection).

In the illustrated embodiment, the first uninterruptable power supply 106 can disconnect (open connection) the first breaker 174 from the first electrical bus 111 when there is a major fault with the first uninterruptable power supply 106, e.g., a fault with the inverter or the rectifier. The first uninterruptable power supply 106 can activate the first breaker 174 to reconnect (closed connection) to the first electrical bus 111 when the fault condition clears or when the system is locally or remotely reset. For example, the first uninterruptable power supply 106 may control the first breaker 174 via an active/non-active signal that controls whether the first breaker 174 is connected (active) or disconnected (non-active) from the first electrical bus 111. Similarly, the second uninten⁻uptable power supply 122 can disconnect the second breaker 176 from the second electrical bus 113 when there is an overheating fault with the second uninterruptable power supply 122, for example. The second uninterruptable power supply 122 can also activate the second breaker 176 to reconnect to the second electrical bus 113 when the fault condition clears or when the system is locally or remotely reset. The second uninterruptable power supply 122 may control the second breaker 176 via an active/non-active signal that controls whether the second breaker 176 is connected or disconnected from the second electrical bus 113.

Furthermore, the system 100 illustrated in FIG. 7 includes a transfer load switch 178 that is in electrical communication between the load 108 and both the first uninterruptable power supply 106 and the second uninterruptable power supply 122. The transfer load switch 178 can be an electro-mechanical or electro-static device that is in electrical communication with a decision support logic controller 180 configured to monitor the first uninterruptable power supply 106 and the second uninterruptable power supply 122 and to control operation of the transfer load switch 178. In another embodiment, the transfer load switch can be a mechanical switch.

By monitoring the uninterruptable power supplies and controlling operation of the transfer load switch, the decision support logic controller 180 is configured to balance the loading of the uninterruptable power supplies. For example, the controller 180 can select the uninterruptable power supply that has the most available capacity or may select the uninterruptable power supply that has the best quality power. In another embodiment, the controller can be configured to select or balance the uninterruptable power supplies by other parameters, e.g., type of uninterruptable power supply, type of AC connection and/or cost of electricity from the AC connection, or the like. In the illustrated embodiment, the transfer load switch 178 includes a first disconnect switch 182 and a second disconnect switch 184 that may be operatively controlled by the controller 180. For example, in the illustrated embodiment, the controller 180 may sense that the first uninterruptable power supply 106 is developing a number of minor faults that make the reliability of the power supply questionable, therefore, the controller 180 operatively disconnects the first uninterruptable power supply 106 by opening (disconnecting) the first disconnect switch 182. Therefore, the second uninterruptable power supply 122 is supplying power to load 108 through the second disconnect switch 184 shown in a closed (connected) position. In another embodiment, the system 100 illustrated in FIG. 7 may include more than two uninterruptable power supplies and the uninterruptable power supplies may be supplying power to more than one load. In yet another embodiment, there may be more than one transfer load switch and more than one decision support logic controller and the controller may monitor other components of the system 100. In another embodiment, the disconnect switches may be single pole and/or dual pole switches.

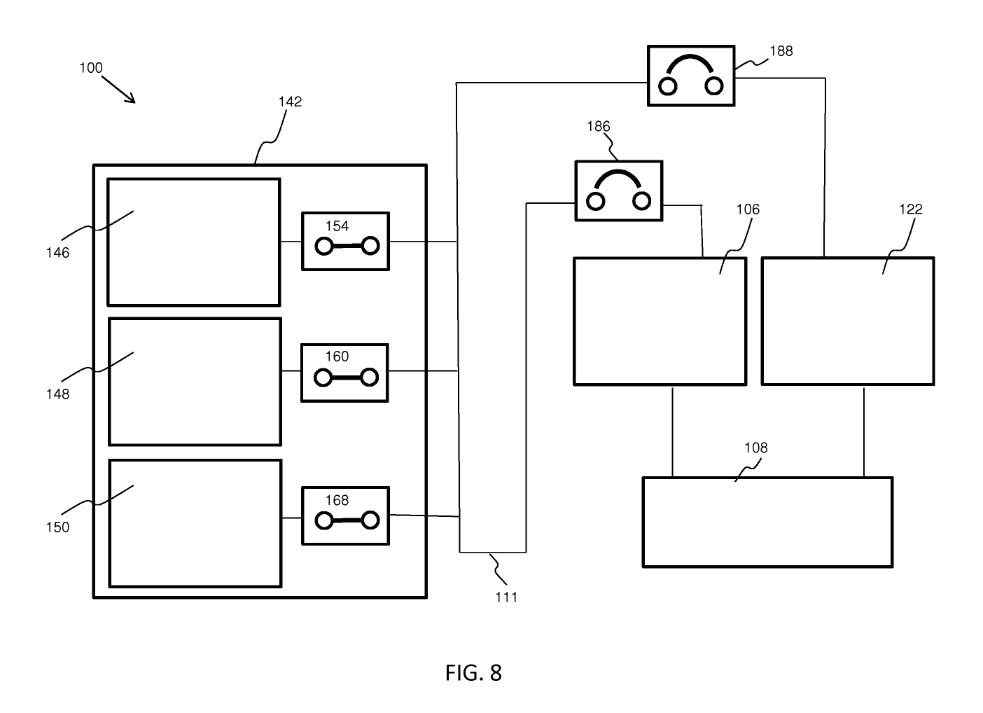

FIG. 8 is an electrical schematic of another embodiment of the system 100 that is similar to the system 100 discussed above and illustrated in FIG. 1, except the system 100 illustrated in FIG. 8 does not include the controller 144 and includes a single bus configuration having batteries with disconnect switch assemblies having one dual pole switch to minimize costs and to maximize design simplicity. For example, switches 154, 160, and 168 are electrically connected to each battery 146, 148, and 150, respectively, and are in electrical communication with a first electrical bus 111. The first electrical bus Ill is in electrical communication with the first uninterruptable power supply 106 and the second uninterruptable power supply 122. Furthermore, the first uninterruptable power supply 106 is electrically connected to a first UPS disconnect switch 186, e.g., a breaker, and the second uninterruptable power supply 122 is electrically connected to a second UPS disconnect switch 188, e.g., a breaker. In one embodiment, the first uninterruptable power supply 106 may operatively control the first UPS disconnect switch 186 via an active/non-active signal that controls whether the first UPS disconnect switch 186 is connected (active) or disconnected (non-active) from the first electrical bus 111. In another embodiment, the first UPS disconnect switch 186 is a manual switch that is activated by a user of the system. Similarly, the second uninterruptable power supply 122 may operatively control the second UPS disconnect switch 188 or it may be manually controlled by the user of the system. In another embodiment, the system illustrated in FIG. 8 may further include a transfer load switch as discussed above, including a decision support logic controller.

In the illustrated embodiment, the switch 154 can be selectively controlled (manually or automatically) to connect or disconnect battery 146 to the first UPS disconnect switch 186 and the first uninterruptable power supply 106 and/or the second UPS disconnect switch 188 and the second uninterruptable power supply 122. In addition, the switch 160 can be selectively controlled to connect or disconnect battery 148 to the first UPS disconnect switch 186 and the first uninterruptable power supply 106 and/or the second UPS disconnect switch 188 and the second uninterruptable power supply 122. The switch 168 can be selectively controlled to connect or disconnect battery 148 to the first UPS disconnect switch 186 and the first uninterruptable power supply 106 and/or the second UPS disconnect switch 188 and the second uninterruptable power supply 122.

Embodiments of the invention utilize a single energy storage device for providing electrical power to plural uninterruptable power supplies. In one embodiment, a system comprises an energy storage device, a switch, a bus, and first and second uninterruptable power supplies. The switch is controllable to an on state (establishing an electrical connection) and an off state (establishing an electrical open condition, i.e., no electrical connection). The switch is operably connected to the bus between the uninterruptable power supplies and the energy storage device. When the switch is controlled to the on state, an electrical connection is established between the energy storage device and the uninterruptable power supplies over the bus. When the switch is controlled to the off state, there is no electrical connection between the energy storage device and the uninterruptable power supplies. In another embodiment, the system further includes a control element (controller, local monitor device(s), or the like) that is operably connected to the switch, for controlling the switch to the on state and the off state, depending on a current mode of operation of the system and/or based on one or more conditions of the system as monitored by the control element.

In another embodiment, a system comprises first and second batteries (e.g., connected in parallel), first and second switches, a bus, and first and second uninterruptable power supplies. Each switch is controllable to an on state (establishing an electrical connection) and an off state (establishing an electrical open condition). The first switch is operably connected to the bus between the uninterruptable power supplies and the first battery. The second switch is operably connected to the bus between the uninterruptable power supplies and the second battery. When the first switch is controlled to the on state, an electrical connection is established between the first battery and the uninterruptable power supplies over the bus. When the first switch is controlled to the off state, there is no electrical connection between the first battery and the uninterruptable power supplies. Similarly, when the second switch is controlled to the on state, an electrical connection is established between the second battery and the uninterruptable power supplies over the bus. When the second switch is controlled to the off state, there is no electrical connection between the second battery and the uninterruptable power supplies. In another embodiment, the system further includes a control element (controller, local monitor device(s), or the like) that is operably connected to the first and second switches, for controlling the switches to the on state and the off state, depending on a current mode of operation of the system and/or based on one or more conditions of the system monitored by the control element. In one mode of operation, both switches are in the on state, and both batteries are electrically connected to the uninterruptable power supplies. In a second mode of operation, one switch is in the on state, and the other switch is in the off state; thus, only one of the two batteries is electrically connected to the uninterruptable power supplies. In a third mode of operation, both switches are in the off state, and neither battery is electrically connected to the uninterruptable power supplies. In other embodiments, there are more than two batteries and more than two switches, with each battery having a switch associated therewith for controllably electrically connecting and disconnecting the battery from the bus and uninterruptable power supplies.

In another embodiment, a system comprises an energy storage device, first and second switches, first and second buses, and first and second uninterruptable power supplies. Each switch is controllable to an on state (establishing an electrical connection) and an off state (establishing an electrical open condition, i.e., no electrical connection). The first switch is operably connected to the first bus between the first uninterruptable power supply and the energy storage device. When the first switch is controlled to the on state, an electrical connection is established between the energy storage device and the first uninterruptable power supply over the first bus. When the first switch is controlled to the off state, there is no electrical connection between the energy storage device and the first uninterruptable power supply. The second switch is operably connected to the second bus between the second uninterruptable power supply and the energy storage device. When the second switch is controlled to the on state, an electrical connection is established between the energy storage device and the second uninterruptable power supply over the second bus. When the second switch is controlled to the off state, there is no electrical connection between the energy storage device and the second uninterruptable power supply. In another embodiment, the system further includes a control element (controller, local monitor device(s), or the like) that is operably connected to the switches, for controlling the switches to the on state and the off state, depending on a current mode of operation of the system and/or based on one or more conditions of the system as monitored by the control element. In one mode of operation, both switches are in the on state, and the energy storage device is electrically connected to both uninterruptable power supplies. In a second mode of operation, one switch is in the on state, and the other switch is in the off state; thus, the energy storage device is electrically connected to one of the uninterruptable power supplies only. In a third mode of operation, both switches are in the off state, and the energy storage device is electrically connected to neither of the uninterruptable power supplies.

In another embodiment, a system comprises first and second batteries, first, second, third, and fourth switches, first and second buses, and first and second uninterruptable power supplies. Each switch is controllable to an on state (establishing an electrical connection) and an off state (establishing an electrical open condition, i.e., no electrical connection). The first switch is operably connected to the first bus between the first uninterruptable power supply and the first battery. When the first switch is controlled to the on state, an electrical connection is established between the first battery and the first uninterruptable power supply over the first bus. When the first switch is controlled to the off state, there is no electrical connection between the first battery and the first uninterruptable power supply. The second switch is operably connected to the second bus between the second uninterruptable power supply and the first battery. When the second switch is controlled to the on state, an electrical connection is established between the first battery and the second uninterruptable power supply over the second bus. When the second switch is controlled to the off state, there is no electrical connection between the first battery and the second uninterruptable power supply. The third switch is operably connected to the first bus between the first uninterruptable power supply and the second battery. When the third switch is controlled to the on state, an electrical connection is established between the second battery and the first uninterruptable power supply over the first bus. When the third switch is controlled to the off state, there is no electrical connection between the second battery and the first uninterruptable power supply. The fourth switch is operably connected to the second bus between the second uninterruptable power supply and the second battery. When the fourth switch is controlled to the on state, an electrical connection is established between the second battery and the second uninterruptable power supply over the second bus. When the fourth switch is controlled to the of state, there is no electrical connection between the second battery and the second uninterruptable power supply.

In another embodiment, the system further includes a control element (controller, local monitor device(s), or the like) that is operably connected to the switches, for controlling the switches to the on state and the off state, depending on a current mode of operation of the system and/or based on one or more conditions of the system as monitored by the control element. In a first mode of operation (“all on” mode), all the switches are controlled to the on state, and both batteries are electrically connected to both uninterruptable power supplies. In a second mode of operation (“all off' mode), all the switches are controlled to the off state, and neither of the batteries is electrically connected to the uninterruptable power supplies. In a third mode of operation (”battery isolation” mode), the first and second switches are controlled to the on state, and the third and fourth switches are controlled to the off state. Here, the first battery is electrically connected to both uninterruptable power supplies, and the second battery is electrically connected to neither. (In a similar mode of operation, the third and fourth switches are controlled to the on state and the first and second switches to the off state, for the second battery to be electrically connected to both uninterruptable power supplies and the first battery to be electrically connected to neither.) In a fourth mode of operation (“UPS isolation” mode), the first and third switches are controlled to the on state, and the second and fourth switches are controlled to the off state. Here, both batteries are electrically connected to the first uninterruptable power supply, and neither battery is electrically connected to the second uninterruptable power supply. Similarly, the second and fourth switches may be controlled to the on state, and the first and third switches controlled to the off state. Here, both batteries are electrically connected to the second uninterruptable power supply, and neither battery is electrically connected to the first uninterruptable power supply.

Another embodiment relates to a system comprising first and second uninterruptable power supplies, first and second busses respectively electrically connected to the first and second uninterruptable power supplies, first and second batteries, and first and second disconnect switch assemblies. The first disconnect switch assembly is operably coupled between the first battery and the first and second busses, and the second disconnect switch assembly is operably coupled between the second battery and the first and second busses. (Each assembly may include two switches.) The first and second disconnect switch assemblies are controllable to: a first mode of operation where both batteries are electrically connected to both uninterruptable power supplies; a second mode of operation where neither battery is electrically connected to the uninterruptable power supplies; a third mode of operation where one of the batteries is electrically connected to both uninterruptable power supplies and the other battery is electrically connected to neither uninterruptable power supply; and a fourth mode of operation where both batteries are electrically connected to one of the uninterruptable power supplies only and not the other of the uninterruptable power supplies. In another embodiment, in the third mode of operation, the other battery (the one not connected to either UPS) is connected to no UPS's, and may be electrically isolated. In another embodiment, in the fourth mode of operation, the UPS that is not electrically connected to either battery is connected to no batteries or other energy sources, and thereby is electrically isolated at least from the energy sources/devices.

Another embodiment relates to a system comprising an energy storage device and two uninterruptable power supplies switchably coupled to the energy storage device via at least one electrical bus. The system further comprises at least one disconnect switch assembly operably coupled between the energy storage device and the at least one electrical bus. The at least one disconnect switch assembly is controllable to different modes of operation. In a first mode of operation of the at least one disconnect switch assembly, the energy storage device is electrically connected to neither of the two uninterruptable power supplies. In a second mode of operation of the at least one disconnect switch assembly, the energy storage device is electrically connected to both of the two uninterruptable power supplies such that both uninterruptable power supplies can receive power from all energy storage parts/components of the energy storage device. In a third mode of operation of the at least one disconnect switch assembly, the energy storage device is electrically connected to one of the two uninterruptable power supplies only and not to the other of the two uninterruptable power supplies. The system may further comprise a control element that is operably coupled to the at least one disconnect switch assembly for controlling the at least one disconnect switch assembly to the different modes of operation, e.g., automatically based on monitored operating conditions of the system, based on a control input, or based on a control scheme established by an operator.

In embodiments of the system having plural batteries or other energy storage elements, even if one of the batteries or other energy storage elements fails, the system is still able to provide electrical power to both/all uninterruptable power supplies, e.g., by controlling the switches/disconnect switch assembly(ies) to electrically isolate the failed energy storage element and electrically connect one or more of the healthy energy storage elements.

Although embodiments have been illustrated as the single energy storage device and disconnect switch assemblies being assembled as a single unit or package, in other embodiments, such components are not in the same unit or package, e.g., the batteries and disconnect switch assemblies may be separately housed but electrically connected together, as described above, using suitable wiring/cables.

In the appended claims, the terms “including” and “having” are used as the plain language equivalents of the terms “comprising”; the term “in which” is equivalent to “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differentiate from the literal language of the claims, or if they include equivalent structural elements with insubstantial differences from the literal language of the claims.

What is claimed is:

1. A system, comprising:
a single energy storage device;
a first uninterruptable power supply switchably coupled to the single energy storage device via a first electrical bus; and
at least one second uninterruptable power supply switchably coupled to the single energy storage device via at least one second electrical bus.

2. The system according to claim 1, further comprising at least one disconnect switch assembly that includes at least two switches including a first switch coupled to the first uninterruptable power supply via the first electrical bus, and a second switch coupled to the at least one second uninterruptable power supply via the at least one second electrical bus, and each switch having an on state and an off state to enable the single energy storage device to electrically communicate with a respective uninterruptable power supply when the switch is in the on state.

3. The system according to claim 2, wherein the at least one disconnect switch assembly is operatively connected and external to the single energy storage device.

4. The system according to claim 2, wherein the at least one disconnect switch assembly is operatively connected and internal to the single energy storage device.

5. The system according to claim 1, wherein the single energy storage device is a single assembled package.

6. The system according to claim 1, wherein the single energy storage device includes at least two battery cells configured to supply a voltage requirement of the first uninterruptable power supply and the at least one second uninterruptable power supply.

7. The system according to claim 1, wherein the single energy storage device includes at least two batteries in parallel, and wherein the at least two batteries are electro-chemical energy storage elements.

8. The system according to claim 1, wherein the single energy storage device includes at least one of at least two electro-mechanical energy storage elements in parallel or at least two electro-static energy storage elements in parallel.

9. The system according to claim 2, wherein each of the first switch and the second switch are two-pole switches.

10. The system according to claim 2, wherein the switches of the at least one disconnect switch assembly are at least one of contact switches, motor actuated switches, motor actuated breakers, or circuit breakers.

11. The system according to claim 1, further comprising at least one grid alternating current feed connectable to the first uninterruptible power supply and the at least one second uninterruptable power supply.

12. The system according to claim 2, further comprising a controller configured to control the at least one disconnect switch assembly and switching of the at least two switches of the at least one disconnect switch assembly to the on and off states.

13. The system according to claim 12, wherein the controller is further configured to monitor the system for detection of an operating event and control the at least one disconnect switch assembly in response to said monitoring.

14. The system according to claim 12, wherein the controller is further configured to monitor the system for detection of an operating event comprising at least one of a source fault of the single energy storage device or an overheating condition of the single energy storage device.

15. The system according to claim 12, wherein the controller is further configured to monitor the system for detection of an operating event comprising at least one of an uninterruptable power supply fault, an overheating uninterruptable power supply, or a supply voltage fault.

16. The system according to claim 12, wherein the controller is further configured to monitor the system for detection of an operating event, including at least a disconnect switch assembly fault.

17. The system according to claim 12, wherein the controller is further configured to control the at least one disconnect switch assembly in response to a manual command.

18. The system according to claim 12, wherein the controller is further configured to control whether the switches of the at least one disconnect switch assembly are in one of an on state or an off state between the single energy storage device and at least one of the first uninterruptable power supply or the at least one second uninterruptable power supply.

19. The system according to claim 2, wherein the single energy storage device includes at least one local monitor device configured to detect at least one of a source fault or an overheating condition of said single energy storage device, and wherein the at least one local monitor device is further configured to disconnect at least a portion of the single energy storage device from at least one of the electrical buses via the at least one disconnect switch assembly in response to detecting said at least one of the source fault or the overheating condition.

20. The system according to claim 1, further comprising a first breaker electrically coupled between the first electrical bus and the first uninterruptable power supply and a second breaker electrically coupled between the at least one second electrical bus and the at least one second uninterruptable power supply, wherein the first uninterruptable power supply is configured to control the first breaker and the at least one second uninterruptable power supply is configured to control the second breaker.

21. The system according to claim 1, further comprising a transfer load switch electrically coupled between at least one load and at least the first uninterruptable power supply and the at least one second uninterruptable power supply.

22. The system according to claim 21, further comprising a controller that monitors at least one of the first uninterruptable power supply, the at least one second uninterruptable power supply, or the transfer load switch, wherein the controller controls the transfer load switch to electrically connect at least one of the first uninterruptable power supply or the at least one second uninterruptable power supply to the load,

23. A system, comprising:
a single energy storage device; and
a first uninterruptable power supply and at least one second uninterruptable power supply switchably coupled to the single energy storage device via a first electrical bus.

24. The system according to claim 23, further comprising at least one disconnect switch assembly that includes a switch coupled to the first uninterruptable power supply and to the at least one second uninterruptable power supply via the first electrical bus, and said switch having an on state and an off state to enable the single energy storage device to electrically communicate with the first uninterruptable power supply and the at least one second uninterruptable power supply when the switch in the on state.

25. The system according to claim 24, wherein the at least one disconnect switch assembly is operatively connected and external to the single energy storage device.

26. The system according to claim 24, wherein the at least one disconnect switch assembly is operatively connected and internal to the single energy storage device.

27. The system according to claim 24, further comprising a controller configured to control switching of the switch between the on state and the off state.

28. The system according to claim 24, wherein the single energy storage device includes at least one local monitor device configured to detect at least one of a source fault or an overheating condition of said single energy storage device, and wherein the at least one local monitor device is further configured to disconnect at least a portion of the single energy storage device from the first electrical bus via the at least one disconnect switch assembly in response to detecting said at least one of the source fault or the overheating condition.

29. A method comprising:
controlling at least one disconnect switch assembly to supply backup power from a single energy storage device to at least two uninterruptable power supplies, including a first uninterruptable power supply and a second uninterruptable power supply, over at least two electrical buses.

30. The method according to claim 29, further comprising replacing at least one battery in the single energy storage device, wherein the at least one battery is replaced without interrupting the backup power to the at least two uninterruptable power supplies.

31. The method according to claim 29, further comprising monitoring at least the single energy storage device for fault conditions.

32. The method according to claim 29, further comprising monitoring at least the at least two uninterruptable power supplies for fault conditions.

33. The method according to claim 29, further comprising:
in a first mode of operation, switching the at least one disconnect switch assembly to connect the single energy storage device only to the first uninterruptable power supply; and
in a second mode of operation, switching the at least one disconnect switch assembly to connect the single energy storage device only to the second uninterruptable power supply.

34. The method according to claim 29, further comprising, in a third mode of operation, switching the at least one disconnect switch assembly to connect the single energy storage device to both the first uninterruptable power supply and the second uninterruptable power supply.

35. The method according to claim 29, further comprising responding to a battery fault of the single energy storage device by disconnecting at least one of the at least one disconnect switch assembly from at least one of the at least two electrical buses.

36. The method according to claim 29, further comprising controlling the at least two uninterruptable power supplies to supply input power from at least one alternating current feed to at least one of the single energy storage device or a load.
